(19) United States
(12) Patent Application Publication
(10) Pub. No.: US 2009/0167663 A1
(43) Pub. Date: Jul. 2, 2009

(54) Liquid Crystal Display Apparatus and Bandgap Reference Circuit Thereof

(75) Inventors: Ming-Dou Ker, Hsinchu (TW); Hsiao-Wen Zan, Hsinchu (TW); Ting-Chou Lu, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 12/102,277

(22) Filed: Apr. 14, 2008

(30) Foreign Application Priority Data
Dec. 31, 2007 (TW) 96151404

(51) Int. Cl. G09G 3/36; G05F 3/02

(52) U.S. Cl. 345/92; 327/539

(57) ABSTRACT

A liquid crystal display apparatus comprises a system-on-glass (SOG) and a bandgap reference (BGR) circuit. The BGR circuit, which is formed on the SOG, comprises a current mirror set and a diode set. The current mirror set is configured to generate a plurality of fixed currents. The diode set, which is formed by a plurality of diode-connected thin film transistors (TFT), is configured to generate a BGR voltage according to the fixed currents.

This application claims the benefit of priority based on Taiwan Patent Application No. 096151404, filed on Dec. 31, 2007, the contents of which are incorporated herein by reference in their entirety.

### CROSS-REFERENCES TO RELATED APPLICATIONS

Not applicable.

### BACKGROUND OF THE INVENTION

1. Field of the Invention

The present invention relates to a liquid crystal display (LCD) apparatus with a system-on-glass (SOG) and a bandgap reference (BGR) circuit for use in the SOG

2. Descriptions of the Related Art

In recent years, flat panel displays have rapidly developed and replaced conventional cathode ray tube (CRT) displays. Current flat panel displays include: organic light-emitting diode displays (OLEDs), plasma display panels (PDPs), liquid crystal displays (LCDs), and field emission displays (FEDs). Among these flat panel displays, LCDs have developed into the mainstream product in the display market due to their advantages such as low power consumption, light weight, slim profiles and high definition.

A typical LCD comprises a lot of drive circuits and control circuits, both of which require fixed reference voltages to maintain normal operation. If there was no fixed reference voltage provided for these circuits to maintain normal operation, disoperation or improper display would occur to the LCD. In the integrated circuit (IC) technologies of the prior art, there are a wide variety of circuits capable of generating fixed reference voltages. When an LCD is powered on, it will experience a considerable variation in the internal temperature. Therefore, bandgap reference (BGR) voltages, which are insensitive to temperature, become the important source of reference voltages required in various drive circuits and control circuits of LCDs.

As shown in FIG. 1, a typical BGR circuit 1 comprises a current mirror set 11, a diode set 13, a first resistor 15, a second resistor 17, a power terminal V_{DD}, a ground terminal V_{SS} and a reference voltage node V_{REF}. The current mirror set 11 comprises a plurality of transistors 110, 111, 112, 113, 114. The transistors 110, 111, 112 form a current mirror, while the transistors 113 and 114 form the other current mirror. The current mirrors included in the current mirror set 11 are used in conjunction to generate identical fixed currents I₁ₐ, I_{1b} and I_{1c}. The diode set 13 comprises a plurality of diode-connected bipolar junction transistors (BJTs) 131, 132, 133. When the fixed currents I₁ₐ, I_{1b} and I_{1c} flow through the first resistor 15, the second resistor 17, and the BJTs 131, 132, 133 of the diode set 13, a BGR voltage immune to interference from temperature variation will be generated at the reference voltage node V_{REF}.

Another kind of BGR circuit 2 is shown in FIG. 2. The BGR circuit 2 comprises a plurality of transistors 21, 22, an operational amplifier (OPAMP) 23, a diode set 24, a first resistor 25, a second resistor 26, a third resistor 27, a power terminal V_{DD}, a ground terminal V_{SS}, and a reference voltage node V_{REF}. The transistors 21, 22, the OPAMP 23, the first resistor 25, and the second resistor 26 are used in conjunction to generate identical fixed currents I₂ₐ and I_{2b}. Likewise, the diode set 24 comprises a plurality of diode-connected BJTs 241, 242. When the fixed currents I₂ₐ and I_{2b} flow through the third resistor 27 and the BJTs 241, 242 of the diode set 24, a BGR voltage immune to interference from temperature variation will be generated at the reference voltage node V_{REF}.

In an attempt to further minimize volume of an LCD, manufacturers have developed a manufacturing technology known as a system-on-glass (SOG) method, i.e., the originally independent drive circuits and control circuits are formed directly on a display panel, thereby to save both space and cost required to separately manufacture the drive circuits and control circuits. Conventional BGR circuits used in the aforesaid drive circuits and control circuits all use diode-connected BJTs and a plurality of fixed currents to generate a BGR voltage. However, the characteristics of the BJTs make it impossible to form the BJTs onto a glass substrate through prior art manufacturing processes. Consequently, BGR circuits with BJTs cannot be applied in an LCD manufactured using the SOG technology.

In view of this, it is important to manufacture a reference voltage generating circuit that can be made on a glass substrate and also provide a BGR voltage insensitive to temperature.

### SUMMARY OF THE INVENTION

In view of the aforesaid problems confronted by the prior art, the primary objective of this invention is to provide an LCD comprising an SOG and a BGR circuit formed on the SOG. The BGR circuit, which is configured to generate a BGR voltage, comprises a first power terminal, a second power terminal, a current mirror set and a diode set. The current mirror set is coupled to the first power terminal and is configured to generate a plurality of fixed currents. The diode set, which is formed by a plurality of diode-connected Thin Film Transistors (TFTs), is coupled to the current mirror set and the second power terminal and is configured to generate a BGR voltage according to the fixed currents.

To make it possible to form a BGR circuit on an SOG, BJTs employed in the prior art technologies are replaced by TFTs in this invention. As TFTs have much the same electrical characteristics as BJTs, the problem that a BGR circuit having BJTs cannot be made on an SOG is solved. As a result, the BGR circuit with TFTs of this invention will not only be capable of generating a BGR voltage insensitive to temperature, but also be made on an SOG, thus achieving a miniaturized LCD apparatus.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram illustrating a bandgap reference (BGR) circuit of the prior art;

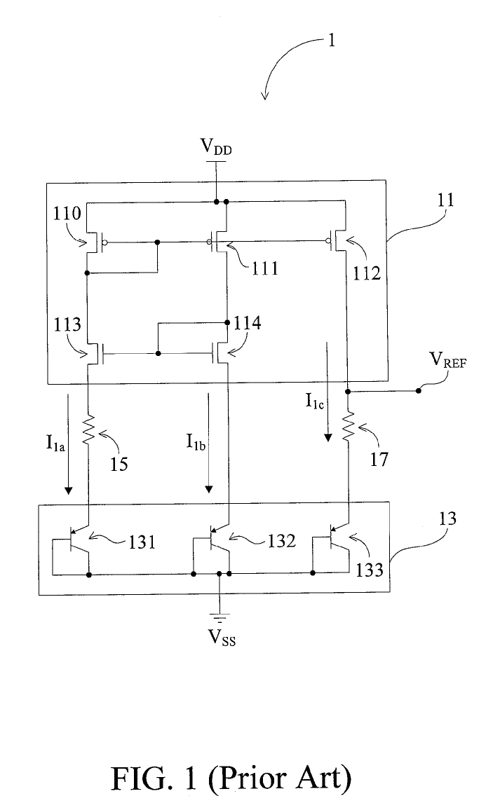

FIG. 2 is a schematic diagram illustrating another bandgap reference (BGR) circuit of the prior art;

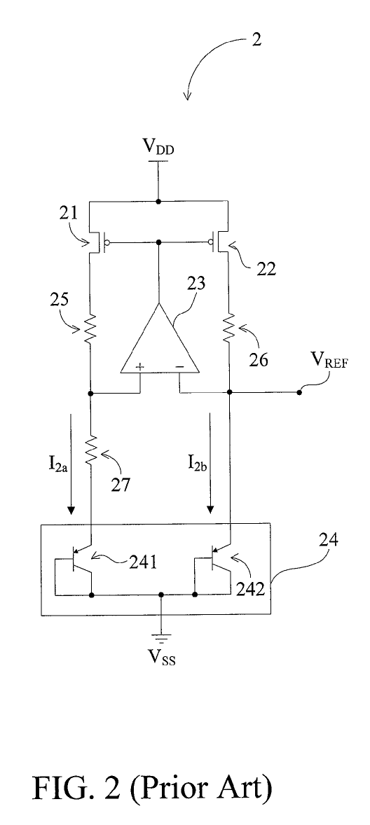

FIG. 3 is a schematic diagram illustrating the first embodiment of this invention;

FIG. 4 is a schematic diagram illustrating the second embodiment of this invention; and

FIG. 5 is a schematic diagram illustrating the third embodiment of this invention.

### DESCRIPTION OF THE PREFERRED EMBODIMENT

In the description that follows, the present invention will be described with reference to embodiments that describe an LCD apparatus and a BGR circuit thereof. The BGR circuit generates a stable reference voltage insensitive to temperature due to the characteristics of circuits and elements thereof However, these embodiments are not intended to limit this invention to any specific context, applications or particular implementations described in these embodiments. Therefore, description of these embodiments is only intended to illustrate rather than to limit this invention. It should be noted that in the following embodiments and attached drawings, elements not directly related to this invention are omitted from depiction; and for ease of understanding, dimensional relationships among individual elements are depicted in an exaggerated manner.

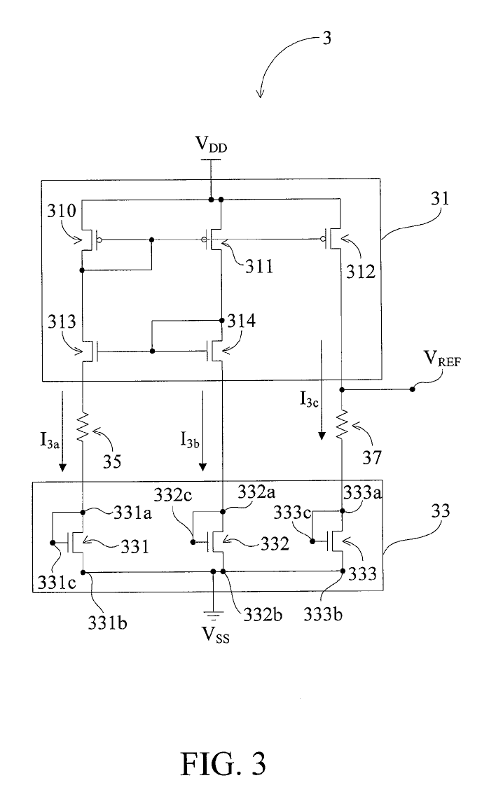

As shown in FIG. 3, a first embodiment of this invention is a BGR circuit 3 formed on an SOG of an LCD apparatus. The BGR circuit 3 comprises a current mirror set 31, a diode set 33, a first resistor 35, a second resistor 37, a first power terminal, a second power terminal, and a reference voltage node V_{REF}. For example, in this embodiment, the first power terminal is a power terminal V_{DD}, and the second power terminal is a ground terminal V_{SS}. The power terminal V_{DD} is adapted to supply a stable direct current (DC) supply. The current mirror set 31 comprises a plurality of transistors 310, 311, 312, 313, 314. The transistors 310, 311, 312 form a first current mirror, while the transistors 313, 314 form a second current mirror. The transistors 310, 311, 312 of the first current mirror are coupled to the power terminal V_{DD} individually, in which the transistors 310, 311 are also coupled to transistors 313, 314 of the second current mirror. Due to the electrical characteristics of the current mirrors, the current mirror set 31 is able to generate a plurality of identical fixed currents I₃ₐ, I_{3b}, and I_{3c}. The current mirror set 31 in this embodiment includes two current mirrors. However, this invention is not just limited thereto, i.e., the current mirror set 31 may also include only a single current mirror or more than two current mirrors. Those of ordinary skill in the art may use other numbers of current mirrors to achieve the objectives of this invention, and therefore descriptions thereof will be omitted herein.

The diode set 33 is formed by a plurality of diode-connected TFTs, i.e., TFTs with electrical characteristics similar to those of diodes. The diode set 33, which is coupled to the current mirror set 31 and the ground terminal V_{SS}, generates a BGR voltage at the reference voltage node V_{REF} according to the first resistor 35, the second resistor 37, and the identical fixed currents I₃ₐ, I_{3b}, and I_{3c} generated by the current mirror set 31.

More specifically, the diode set 33 shown in FIG. 3 is formed entirely by N-type TFTs, i.e., comprises a plurality of N-type TFTs 331, 332 and 333. The N-type TFT 331 includes a gate 331c, a drain 331a and a source 331b; the N-type TFT 332 includes a gate 332c, a drain 332a and a source 332b; and the N-type TFT 333 includes a gate 333c, a drain 333a and a source 333b. To connect these N-type TFTs of the diode set 33 in a diode form, the gates 331c, 332c, 333c of the TFTs 331, 332, 333 are coupled to the drains 331a, 332a, 333a of the TFTs 331, 332, 333 respectively. The sources 331b, 332b, 333b of the TFTs 331, 332, 333 are coupled to the ground terminal V_{SS}. The drains 331a, 332a, 333a of the TFTs 331, 332, 333 receive the identical fixed currents I₃ₐ, I_{3b} and I_{3c} generated by the current mirror set 31. In combination with the first resistor 35 and the second resistor 37, these identical fixed currents I₃ₐ, I_{3b}, and I_{3c} will generate a BGR voltage at the reference voltage node V_{REF}.

In summary, to obtain a stable reference voltage, a current mirror set 31 and a diode set 33 are provided in the BGR circuit 3 to form a biasing circuit. Due to the differences between the current and voltage characteristics of the TFTs, the TFTs of the diode set 33 is able to generate a stable BGR voltage insensitive to temperature at the reference voltage node VREF according to the identical fixed currents I₃ₐ, I_{3b} and I_{3c} generated by the current mirror set 31.

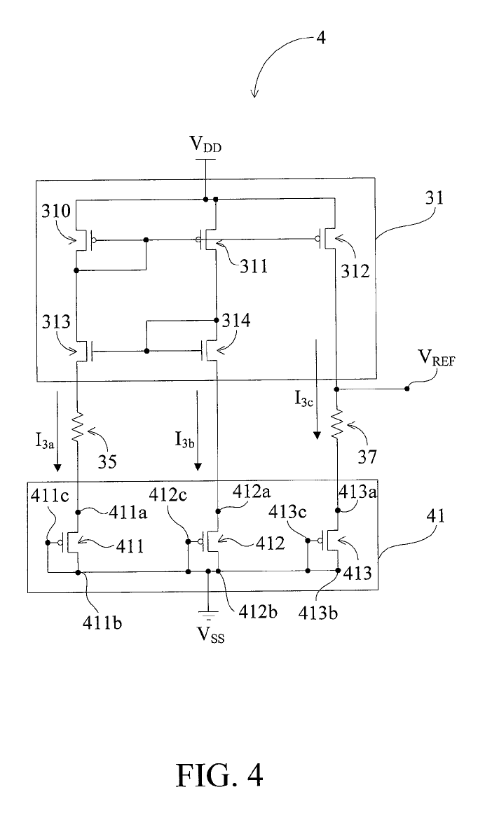

FIG. 4 illustrates a second embodiment of this invention, which is another BGR circuit 4 formed on the SOG of an LCD apparatus. The BGR circuit 4 comprises a current mirror set 31, a diode set 41, a first resistor 35, a second resistor 37, a power terminal V_{DD}, a ground terminal V_{SS} and a reference voltage node V_{REF}. The detailed functions and connections of these elements are just the same as those described in the first embodiment, and therefore no further descriptions will be made herein.

Unlike the first embodiment, the second embodiment is that with the diode set 41 of the BGR circuit 4 diode-connected transistors are all p type TFTs, i.e., the diode set 41 comprises a plurality of P-type TFTs 411, 412, and 413. The P-type TFT 411 includes a gate 411c, a source 411a and a drain 411b; the P-type TFT 412 includes a gate 412c, a source 412a and a drain 412b; and the P-type TFT 413 includes a gate 413c, a source 413a and a drain 413b. To connect these P-type TFTs of the diode set 41 in a diode form, the gates 411c, 412c, 413c of the TFTs 411, 412, 413 are coupled respectively to the drains 411b, 412b, 413b of the TFTs 411, 412, 413, which are in turn coupled to the ground terminal V_{SS}. The sources 411a, 412a, 413a of the TFTs 411, 412, 413 receive the identical fixed currents I₃ₐ, I_{3b}, and I_{3c} generated by the current mirror set 31 respectively. In combination with the resistor 35 and the second resistor 37, these identical fixed currents I₃ₐ, I_{3b}, and I_{3c} will generate a BGR voltage at the reference voltage node V_{REF}.

In addition to the functions described above, the second embodiment may also execute each of the operations and functions described in the first embodiment. The corresponding operations and functions in the second embodiment will readily occur to those of ordinary skill in the art upon reviewing description of the first embodiment, and therefore will not be described herein.

The transistors in the current mirror sets described in the first and the second embodiment may all be field-effect transistors (FETs), TFTs, or FETs in conjunction with TFTs, and are not limited only to TFTs.

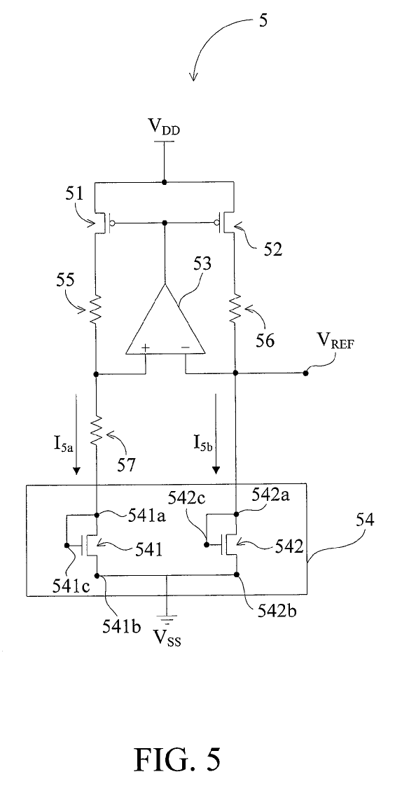

FIG. 5 illustrates a third embodiment of this invention, which is yet another BGR circuit 5 formed on the SOG of an LCD apparatus. The BGR circuit 5 comprises a plurality of transistors 51, 52, an operational amplifier (OPAMP) 53, a diode set 54, a first resistor 55, a second resistor 56, a third resistor 57, a power terminal V_{DD}, a ground terminal V_{SS} and a reference voltage node V_{REF}. The transistors 51, 52, the OPAMP 53, the first resistor 55 and the second resistor 56 are used in conjunction with each other to generate identical fixed currents I₅ₐ and I_{5b}.

Likewise, the diode set 54 is formed by a plurality of diode-connected TFTs, i.e., TFTs with electrical characteristics similar to diodes. The diode set 54, which is coupled to the OPAMP 53 and the ground terminal V_{SS}, generates a BGR voltage at the reference voltage node V_{REF} according to the third resistor 57 and the identical fixed currents I₅ₐ and I_{5b} generated by the OPAMP 53.

More specifically, the diode set 54 shown in FIG. 5 is formed entirely by N-type TFTs, i.e., comprises a plurality of N-type TFTs 541 and 542. The N-type TFT 541 includes a gate 541c, a drain 541a and a source 541b; and the N-type TFT 542 includes a gate 542c, a drain 542a and a source 542b. To connect these N-type TFTs of the diode set 54 in a diode form, the gates 541c, 542c of the TFTs 541, 542 are coupled to the drains 541a, 542a respectively. The sources 541b, 542b of the TFTs 541, 542 are coupled to the ground terminal V_{SS}. The drains 541a, 542a of the TFTs 541, 542 receive the identical fixed currents I₅ₐ and I_{5b} generated by the OPAMP 53. In combination with the third resistor 57, these identical fixed currents I₅ₐ and I_{5b} will generate a BGR voltage at the reference voltage node V_{REF}.

In summary, according to this invention, the current mirror set and diode-connected TFTs are used to form a BGR circuit that can be formed entirely on the SOG to generate a BGR voltage insensitive to temperature. As a result, BJTs can now be formed on a glass substrate, unlike those of the prior art. The BGR circuit is also insensitive to temperature.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A bandgap reference (BGR) circuit for use in system-on-glass (SOG), comprising:
a first power terminal;
a second power terminal;
a current mirror set, coupled to the first power terminal, being configured to generate a plurality of fixed currents; and
a diode set, coupled to the current mirror set and the second power terminal and formed by a plurality of diode-connected Thin Film Transistors (TFTs), being configured to generate a BGR voltage according to the fixed currents.

2. The BGR circuit as claimed in claim 1, wherein the current mirror set is formed by a plurality of current mirrors, and the current mirrors are configured to generate the fixed currents.

3. The BGR reference circuit as claimed in claim 2, wherein one of the current mirrors is formed by a plurality of TFTs.

4. The BGR circuit as claimed in claim 1, wherein the current mirror set is an operational amplifier (OPAMP) configured to generate the fixed currents.

5. The BGR circuit as claimed in claim 1, wherein the TFTs of the diode set are N-type TFTs.

6. The BGR circuit as claimed in claim 5, wherein each of the N-type TFTs comprises a gate, a drain, and a source, the gate of each of the N-type TFTs couples to the drain of each of the same respectively, and the source of each of the N-type TFTs couples to the second power terminal.

7. The BGR circuit as claimed in claim 1, wherein the TFTs of the diode set are P-type TFTs.

8. The BGR circuit as claimed in claim 7, wherein each of the P-type TFTs comprises a gate, a drain, and a source, the gate of each of the P-type TFTs couple to the drain of each of the same respectively, and the drain of each of the P-type TFTs couples to the second power terminal.

9. A liquid crystal display (LCD) apparatus, comprising:
an SOG; and
a BGR circuit, formed on the SOG, being configured to generate a BGR voltage, comprising:
a first power terminal;
a second power terminal;
a current mirror set, coupled to the first power terminal, being configured to generate a plurality of fixed currents; and
a diode set, coupled to the current mirror set and the second power terminal and formed by a plurality of diode-connected TFTs, being configured to generate the BGR voltage according to the fixed currents.

10. The LCD apparatus as claimed in claim 9, wherein the current mirror set of the BGR circuit is formed by a plurality of current mirrors, and the current mirrors are configured to generate the fixed currents.

11. The LCD apparatus as claimed in claim 10, wherein one of the current mirrors is formed by the plurality of TFTs.

12. The LCD apparatus as claimed in claim 9, wherein the current mirror set of the BGR circuit is an OPAMP configured to generate the fixed currents.

13. The LCD apparatus as claimed in claim 9, wherein the TFTs of the diode set of the BGR circuit are N-type TFTs.

14. The LCD apparatus as claimed in claim 13, wherein each of the N-type TFTs comprises a gate, a drain, and a source, the gate of each of the N-type TFTs couples to the drain of each of the same respectively, and the source of each of the N-type TFTs couples to the second power terminal.

15. The LCD apparatus as claimed in claim 9, wherein the TFTs of the diode set of the BGR circuit are P-type TFTs.

16. The LCD apparatus as claimed in claim 15, wherein each of the P-type TFTs comprises a gate, a drain, and a source, the gate of each of the P-type TFTs couples to the drain of each of the same respectively, and the drain of each the P-type TFTs couples to the second power terminal.
